(19) United States
(12) Patent Application Publication
(10) Pub. No.: US 2024/0326722 A1
(43) Pub. Date: Oct. 3, 2024

(54) WIRE HARNESS

(71) Applicant: Yazaki Corporation, Tokyo (JP)

(72) Inventors: Naoto KOGURE, Shizuoka (JP); Hikaru SANO, Shizuoka (JP); Takeshi ONODA, Shizuoka (JP)

(73) Assignee: Yazaki Corporation, Tokyo (JP)

(21) Appl. No.: 18/738,181

(22) Filed: Jun. 10, 2024

Related U.S. Application Data
(63) Continuation of application No. PCT/JP2023/005659, filed on Feb. 17, 2023.

(30) Foreign Application Priority Data
Feb. 28, 2022 (JP) 2022-028840

(51) Int. Cl. B60R 16/02; H02G 11/00

(52) U.S. Cl. CPC B60R 16/0215; H02G 11/006

(57) ABSTRACT

There is provided a harness body that electrically connects a first electrical connection target installed in a slide door and a second electrical connection target installed in a vehicle body, in which when the slide door is at a fully open position with respect to the vehicle body, the harness body is routed on a side of a slide direction during an opening operation of the slide door with respect to a link mechanism that couples the slide door and the vehicle body and reciprocates the slide door in the slide direction with respect to the vehicle body.

### CROSS-REFERENCE TO RELATED APPLICATION(S)

This application is a continuation application of International Application PCT/JP2023/005659, filed on Feb. 17, 2023 which claims the benefit of priority from Japanese Patent Application No. 2022-028840 filed on Feb. 28, 2022 and designating the U.S., the entire contents of which are incorporated herein by reference.

### BACKGROUND OF THE INVENTION

### 1. Field of the Invention

The present invention relates to a wire harness.

### 2. Description of the Related Art

Conventionally, a vehicle such as an automobile is mounted with a wire harness that electrically connects a power source (secondary battery or the like) on a side of a vehicle body, an electrical component, and the like to a switch on a side of a slide door, an electrical component, and the like. This type of wire harness is disclosed in, for example, Japanese Patent Application Laid-open No. 2021-19386 below.

### SUMMARY OF THE INVENTION

In a wire harness for a slide door, since a harness body is routed between a vehicle body and a slide door, there is a possibility that the harness body is exposed when the slide door is at the fully open position. For this reason, in the wire harness, there is a demand for a measure for preventing an occupant, a load, or the like from touching an exposed portion of the harness body at the time of getting on and off.

Therefore, an object of the present invention is to provide a wire harness for a slide door capable of suppressing contact with a harness body at the time of getting on and off.

### Solution to Problem

A wire harness according to one aspect of the present invention includes a harness body that electrically connects a first electrical connection target installed in a slide door and a second electrical connection target installed in a vehicle body, wherein when the slide door is at a fully open position with respect to the vehicle body, the harness body is routed on a side of a slide direction during an opening operation of the slide door with respect to a link mechanism that connects the slide door and the vehicle body and reciprocates the slide door in the slide direction with respect to the vehicle body.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a wire harness of an embodiment when a door is fully opened as viewed from a vehicle interior side;

FIG. 2 is a plan view of the wire harness of the embodiment when the door is fully opened as viewed from above a vehicle;

FIG. 3 is a plan view of the wire harness of the embodiment when the door is fully opened as viewed from the vehicle interior side;

FIG. 4 is a perspective view of the wire harness of the embodiment when the door is fully closed as viewed from the vehicle interior side;

FIG. 5 is a plan view of the wire harness of the embodiment when the door is fully closed as viewed from above the vehicle; and

FIG. 6 is a plan view of the wire harness of the embodiment when the door is fully closed as viewed from the vehicle interior side.

### DETAILED DESCRIPTION OF THE PREFERRED EMBODIMENTS

Hereinafter, an embodiment of a wire harness according to the present invention will be described in detail with reference to the drawings. Note that the present invention is not limited by the embodiment.

### Embodiment

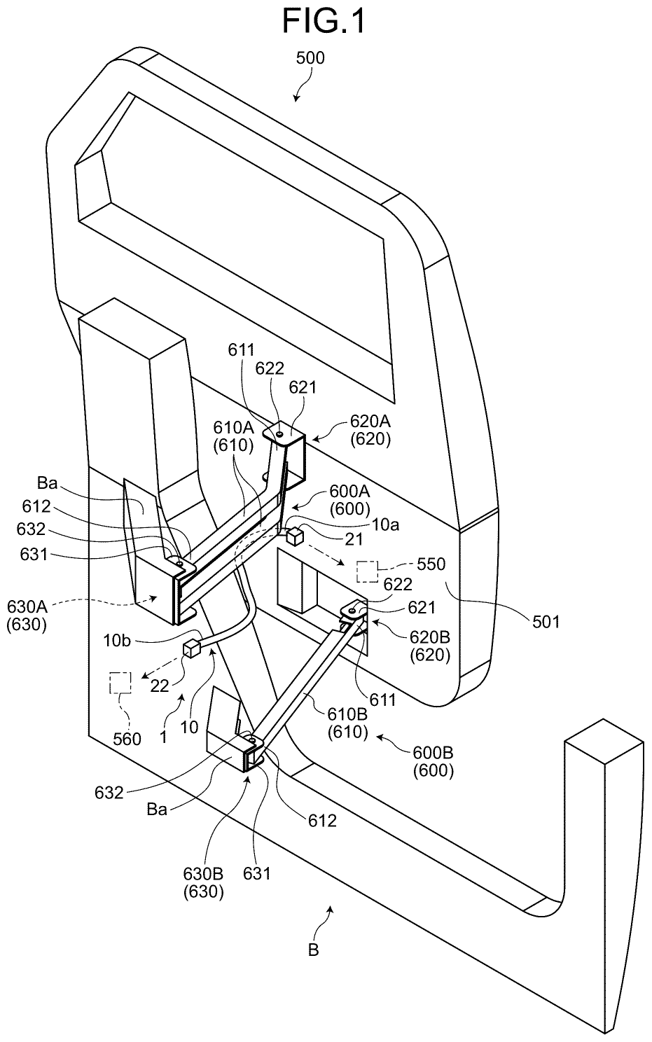

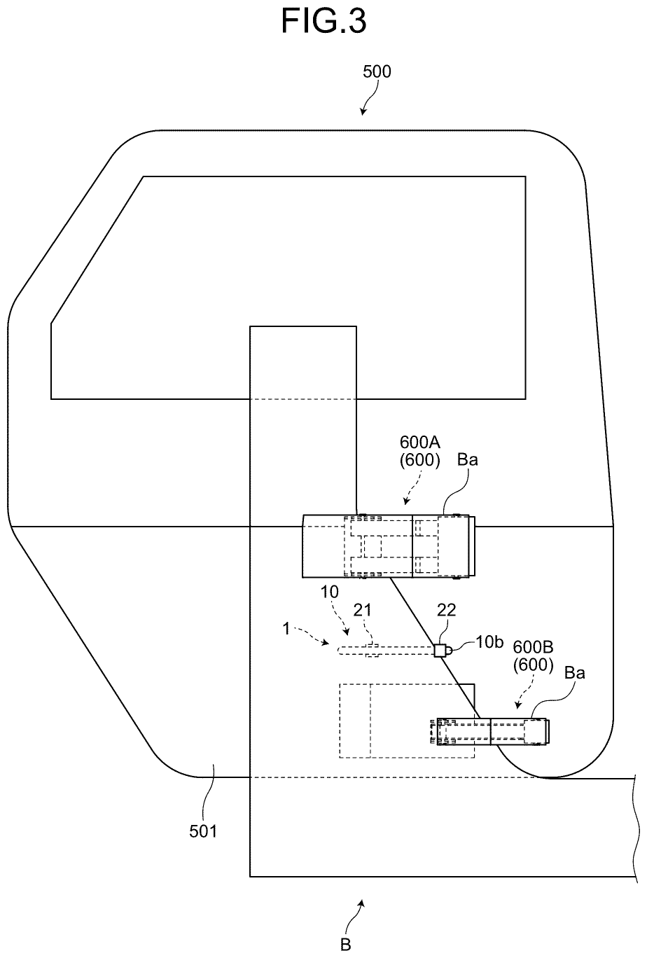

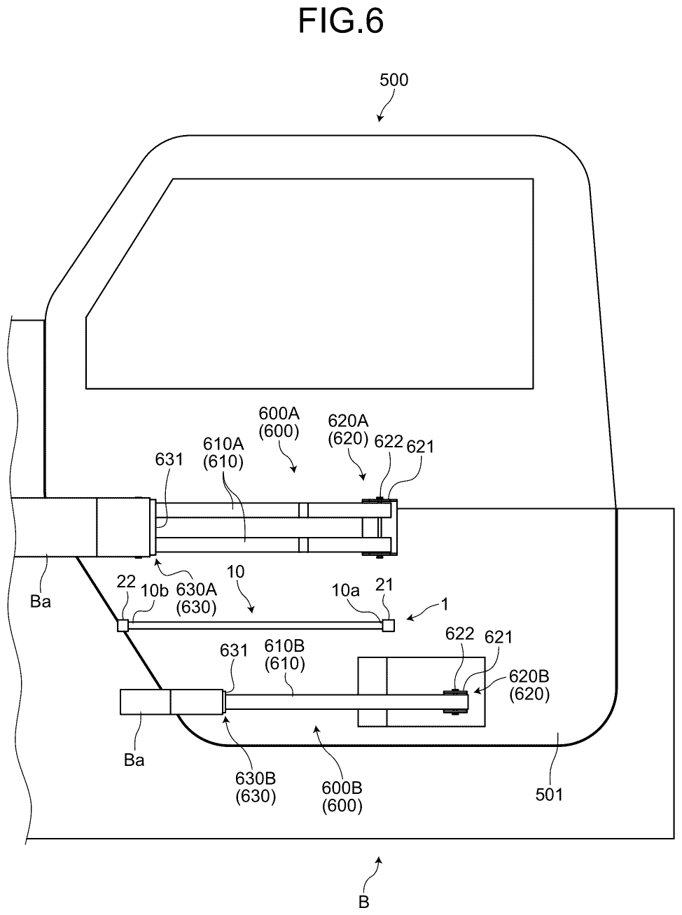

One embodiment of a wire harness according to the present invention will be described with reference to FIGS. 1 to 6.

Reference numeral 1 in FIGS. 1 to 6 denotes a wire harness of the present embodiment.

For example, in a vehicle such as an automobile, there is a vehicle on which a slide door 500 (FIGS. 1 to 6) capable of reciprocating in a slide direction with respect to a vehicle body B is mounted. The vehicle includes a link mechanism 600 that couples the slide door 500 and the vehicle body B and reciprocates the slide door 500 in the slide direction with respect to the vehicle body B in order to take charge of the sliding operation (reciprocating operation in the slide direction) of the slide door 500 (FIGS. 1 to 6). The link mechanism 600 illustrated here slides the slide door 500 on a vehicle side in a vehicle front-rear direction.

The link mechanism 600 passes between the slide door 500 and the vehicle body B to displace the slide door 500 with respect to the vehicle body B between a fully open position and a fully closed position. The link mechanism 600 includes an arm member 610, a first bearing 620 fixed to the slide door 500 and pivotally supporting one end portion 611 of the arm member 610, and a second bearing 630 fixed to the vehicle body B and pivotally supporting the other end portion 612 of the arm member 610 (FIGS. 1, 2, and 4 to 6). That is, the arm member 610 has a turning fulcrum (hereinafter, it is referred to as a “door-side turning fulcrum”) on the slide door 500 side in the link mechanism 600 at one end portion 611, and has a turning fulcrum (hereinafter, it is referred to as a “vehicle body-side turning fulcrum”) on the vehicle body B side in the link mechanism 600 at the other end portion 612.

The first bearing 620 includes a bracket 621 fixed to, for example, an inner panel 501 of the slide door 500, and both ends of a rotating shaft 622 are rotatably and axially supported by the bracket 621 (FIGS. 1, 2, and 4 to 6). The rotating shaft 622 is installed with an axial direction thereof aligned with a vehicle vertical direction. One end portion 611 of the arm member 610 is fixed to the rotating shaft 622, and is pivotally supported rotatably around the axis of the rotating shaft 622 with respect to the bracket 621 via the rotating shaft 622. The second bearing 630 includes a bracket 631 fixed to the vehicle body B, and both ends of the rotating shaft 632 are rotatably and axially supported by the bracket 631 (FIGS. 1, 2, and 4 to 6). The other end portion 612 of the arm member 610 is fixed to the rotating shaft 632, and is pivotally supported rotatably around the axis of the rotating shaft 632 with respect to the bracket 631 via the rotating shaft 632. The bracket 631 is fixed to a fixing portion Ba protruding from the vehicle body B (FIGS. 1, 2, and 4 to 6).

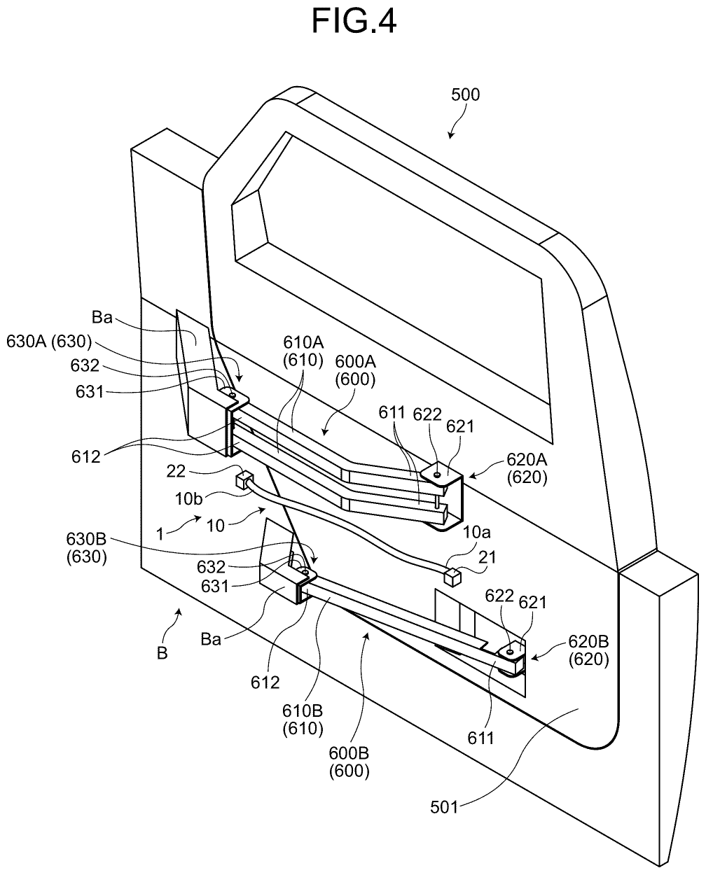

The link mechanism 600 reciprocates the slide door 500 in the slide direction with respect to the vehicle body B while rotating the arm member 610 at the door-side turning fulcrum of the one end portion 611 and the vehicle body-side turning fulcrum of the other end portion 612 by, for example, transmitting an output torque of a rotary machine (not illustrated) as a drive source to the rotating shaft 632 on a side of the vehicle body B. In the link mechanism 600, for example, the arm member 610 is arranged in a state of extending in the slide direction (here, the vehicle front-rear direction) of the slide door 500 when the slide door 500 is at the fully closed position (FIGS. 4 to 6), and the arm member 610 is arranged in a state of extending in an intersecting direction (for example, vehicle width direction) with respect to the slide direction of the slide door 500 when the slide door 500 is at the fully open position (FIGS. 1 to 3).

A plurality of link mechanisms 600 are provided between the slide door 500 and the vehicle body B. The plurality of link mechanisms 600 are arranged at intervals in the vehicle vertical direction. Here, as the link mechanism 600, an upper link mechanism 600A on the vehicle upper side and a lower link mechanism 600B on the vehicle lower side are provided (FIGS. 1 to 6). Here, when the slide door 500 is at the fully open position with respect to the vehicle body B, the lower link mechanism 600B is disposed in front of the vehicle with respect to the upper link mechanism 600A (FIGS. 1 to 3). The upper link mechanism 600A includes two arm members 610A, a first bearing 620A (bracket 621) that pivotally supports one end portion 611 of each of the two arm members 610A via one rotating shaft 622, and a second bearing 630A (bracket 631) that pivotally supports the other end portion 612 of each of the two arm members 610A via one rotating shaft 632 (FIGS. 1, 2, and 4 to 6). The lower link mechanism 600B includes one arm member 610B, a first bearing 620B (bracket 621) that pivotally supports the one end portion 611 of the arm member 610B via the rotating shaft 622, and a second bearing 630B (bracket 631) that pivotally supports the other end portion 612 of the arm member 610B via the rotating shaft 632 (FIGS. 1, 2, and 4 to 6). The drive source is connected to any one of the upper link mechanism 600A and the lower link mechanism 600B.

The wire harness 1 of the present embodiment is mounted on the vehicle in order to electrically connect the first electrical connection target 550 installed in the slide door 500 and the second electrical connection target 560 installed in the vehicle body B (FIG. 1).

The first electrical connection target 550 is installed in the slide door 500 such as an electrical component or a switch. For example, the electrical components of the slide door 500 indicate a drive device that drives a power window, a speaker, and the like. The switch of the slide door 500 indicates a switch for operating a power window, a switch for operating a power seat, and the like. Meanwhile, the second electrical connection target 560 is installed on the side of the vehicle body B such as a power source (secondary battery or the like) or an electrical component. For example, the electrical component on the side of the vehicle body B indicates an acoustic device related to a speaker of the slide door 500, a drive device for driving a power seat, and the like.

The wire harness 1 includes a harness body 10 as a wiring component that electrically connects the first electrical connection target 550 and the second electrical connection target 560 (FIGS. 1 to 6). The harness body 10 may be formed of only an electric wire bundle obtained by bundling a plurality of electric wires, the entire electric wire bundle may be covered with an exterior component such as a corrugated tube, or the electric wire bundle may be partially covered with one or a plurality of exterior components.

In the wire harness 1, one terminal 10a of the harness body 10 is electrically connected to the first electrical connection target 550 directly or indirectly, and the other terminal 10b of the harness body 10 is electrically connected to the second electrical connection target 560 directly or indirectly (FIG. 1). The wire harness 1 illustrated here includes a first connector 21 that is assembled to one terminal 10a of the harness body 10 and electrically connects the harness body 10 to the first electrical connection target 550 directly or indirectly, and a second connector 22 that is assembled to the other terminal 10b of the harness body 10 and electrically connects the harness body 10 to the second electrical connection target 560 directly or indirectly (FIGS. 1 to 6).

The harness body 10 is routed between two adjacent link mechanisms 600 in the vehicle vertical direction (here, between the upper link mechanism 600A and the lower link mechanism 600B) among the plurality of link mechanisms in order to suppress contact of an occupant, cargo, and the like at the time of getting on and off (FIGS. 1 to 6).

Furthermore, the harness body 10 is routed on the side of the slide direction (hereinafter, the direction is referred to as an “opening slide direction”) at the time of the opening operation of the slide door 500 with respect to the link mechanism 600 when the slide door 500 is at the fully open position with respect to the vehicle body B so that an occupant, cargo, and the like are not touched at the time of getting on and off (FIGS. 1 to 3). That is, in the wire harness 1, when the slide door 500 is at the fully open position with respect to the vehicle body B, the harness body 10 is present at the back of the link mechanism 600 as viewed from the occupant, the cargo, and the like at the time of getting on and off. As a result, in the wire harness 1, when the slide door 500 is at the fully open position with respect to the vehicle body B, the contact of the occupant and the cargo with the link mechanism 600 at the time of getting on and off is suppressed, and the occupant and the cargo hardly come into contact with the harness body 10 existing at the back of the link mechanism 600.

For example, in the wire harness 1 illustrated here, both ends of the harness body 10 are arranged at the next positions when the slide door 500 is at the fully open position, so that the harness body 10 is routed on the side of the opening slide direction with respect to the link mechanism 600 when the slide door 500 is at the fully open position with respect to the vehicle body.

First, when the slide door 500 is at the fully closed position with respect to the vehicle body B, the terminal 10a on the side of the first electrical connection target 550 in the harness body 10 is assembled to the side of the slide door 500 at the same position as the coupling portion {here, the bracket 621 (the first bearing 620) and the rotating shaft 622} on the side of the slide door 500 in the link mechanism 600 in the slide direction or on side of the opening slide direction side with respect to the coupling portion on the side of the slide door 500 (FIGS. 4 to 6). That is, in the harness body 10, when the slide door 500 is at the fully closed position, the first connector 21 is connected to the side of the first electrical connection target 550 at the same position as the coupling portion {the bracket 621 (the first bearing 620) and the rotating shaft 622} on the side of the slide door 500 in the link mechanism 600 or on the side of the opening slide direction with respect to the coupling portion on the side of the slide door 500.

Further, when the slide door 500 is at the fully closed position with respect to the vehicle body B, the terminal 10b of the harness body 10 on the side of the second electrical connection target 560 is assembled to the side of the vehicle body B at the same position as the coupling portion {here, the bracket 631 (second bearing 630) and the rotating shaft 632} on the side of the vehicle body B in the link mechanism 600 in the slide direction or on the side of the opening slide direction with respect to the coupling portion on the side of the vehicle body B (FIGS. 4 to 6). That is, in the harness body 10, when the slide door 500 is at the fully closed position, the second connector 22 is connected to the side of the second electrical connection target 560 at the same position as the coupling portion {the bracket 631 (the second bearing 630) and the rotating shaft 632} on the side of the vehicle body B in the link mechanism 600 or on the side of the opening slide direction with respect to the coupling portion on the side of the vehicle body B.

The harness body 10 is routed on the side of the opening slide direction with respect to the link mechanism 600 when the slide door 500 is at the fully open position by the arrangement of the terminals 10a and 10b on the side of the first electrical connection target 550 and the side of the second electrical connection target 560 when the slide door 500 is at the fully closed position. However, since the slack of the harness body 10 increases depending on the path length when the slide door 500 is at the fully open position, there is a possibility that the harness body protrudes toward the side of the slide direction (hereinafter, the direction is referred to as a “closing slide direction”) during the closing operation of the slide door 500 with respect to the link mechanism 600 when the slide door 500 is at the fully open position.

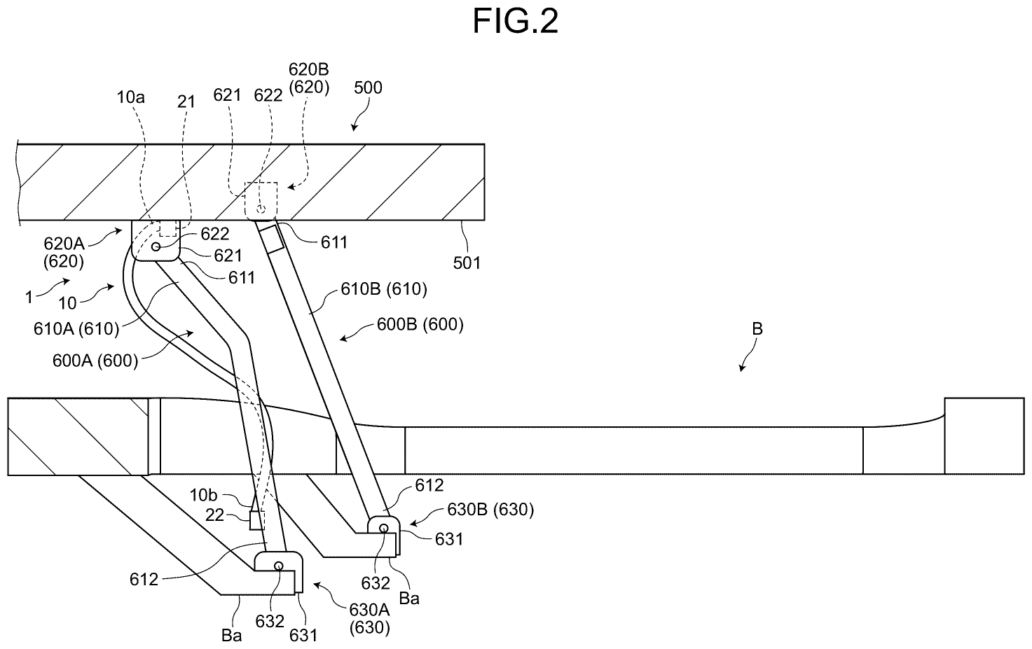

In order to suppress such protrusion, in addition to the arrangement of the respective terminals 10a and 10b described above, for example, when the slide door 500 is at the fully open position with respect to the vehicle body B, the harness body 10 is routed on the side of the opening slide direction with respect to the link mechanism 600 (here, the lower link mechanism 600B) arranged on the most front side of the vehicle among the plurality of link mechanisms 600 arranged at intervals in the vehicle vertical direction (FIG. 2). Accordingly, in the wire harness 1, when the slide door 500 is at the fully open position, it is possible to suppress the protrusion of the harness body 10 toward the side of the closing slide direction with respect to the link mechanism 600 (lower link mechanism 600B). Here, in order to enhance the effect of suppressing the protrusion, when the slide door 500 is at the fully open position with respect to the vehicle body B, the harness body 10 is routed on the side of the opening slide direction with respect to the link mechanism 600 (here, the upper link mechanism 600A) arranged on the side of the opening slide direction with respect to the link mechanism 600 arranged on the most front side of the vehicle among the plurality of link mechanisms 600 arranged at intervals in the vehicle vertical direction.

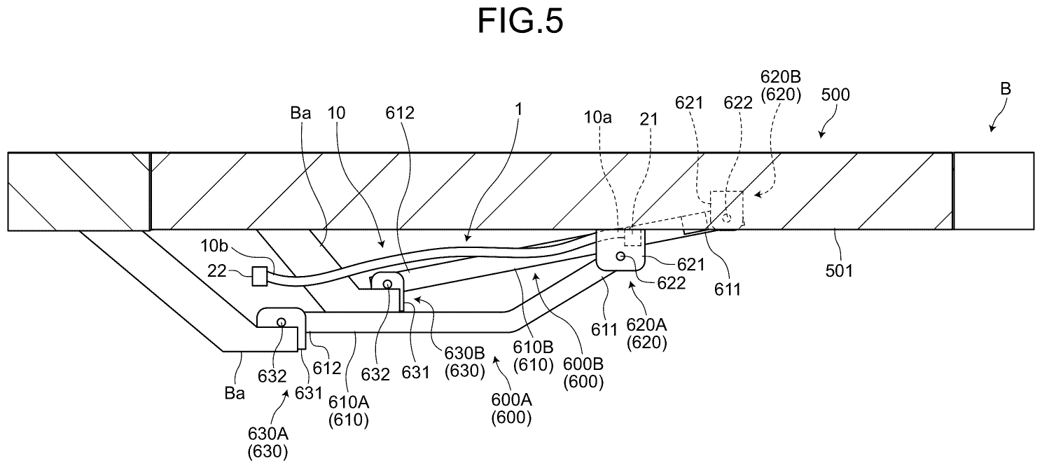

Furthermore, in order to suppress the protrusion, in addition to the arrangement of the terminals 10a and 10b described above, for example, when the slide door 500 is at the fully closed position with respect to the vehicle body B, the harness body 10 is routed immediately above or below the link mechanism 600 or closer to the slide door 500 than the link mechanism 600 (FIG. 5). Accordingly, in the wire harness 1, when the slide door 500 is at the fully open position, it is possible to suppress the protrusion of the harness body 10 toward the side of the closing slide direction with respect to the link mechanism 600 (lower link mechanism 600B).

As described above, in the wire harness 1 of the present embodiment, when the slide door 500 is at the fully open position, the harness body 10 is routed at the back of the link mechanism 600 as viewed from the occupant, the cargo, and the like at the time of getting on and off, and thus, it is possible to suppress the contact of the occupant and the cargo with the harness body 10 at the time of getting on and off. Therefore, the wire harness 1 can enhance the protection function of the harness body 10, and the durability thereof can be improved.

Here, when the slide door 500 is at the fully closed position, the lower link mechanism 600B is disposed above the side sill of the vehicle body B and in a space between the slide door 500 and the floor panel of the vehicle body B or between the slide door 500 and the seat. Therefore, in the wire harness 1, by arranging the harness body 10 in the space when the slide door 500 is at the fully closed position, it is possible to suppress the contact of the occupant and the cargo with the harness body 10 at this time. For example, as described above, the harness body 10 is routed between the upper link mechanism 600A and the lower link mechanism 600B. Therefore, it is desirable that the harness body 10 is routed to the space above the side sill toward the side of the lower link mechanism 600B.

In the wire harness according to the present embodiment, when the slide door is at the fully open position, the harness body is routed behind the link mechanism as viewed from an occupant, a cargo, or the like at the time of getting on and off the vehicle, and thus, it is possible to suppress the contact of the occupant or the cargo with the harness body at the time of getting on and off. Therefore, the wire harness can enhance a protection function of the harness body, and durability thereof can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness comprising:
a harness body that electrically connects a first electrical connection target installed in a slide door and a second electrical connection target installed in a vehicle body, wherein
when the slide door is at a fully open position with respect to the vehicle body, the harness body is routed on a side of a slide direction during an opening operation of the slide door with respect to a link mechanism that connects the slide door and the vehicle body and reciprocates the slide door in the slide direction with respect to the vehicle body.

2. The wire harness according to claim 1, wherein
a terminal on a side of the first electrical connection target in the harness body is assembled to a side of the slide door at a position equivalent to a coupling portion on a side of the slide door in the link mechanism in the slide direction or on a side of the slide direction during the opening operation with respect to the coupling portion on the side of the slide door when the slide door is at a fully closed position with respect to the vehicle body, and
a terminal on a side of the second electrical connection target in the harness body is assembled to a side of the vehicle body at a position equivalent to a coupling portion on the side of the vehicle body in the link mechanism in the slide direction or on a side of the slide direction during the opening operation with respect to the coupling portion on the side of the vehicle body when the slide door is at the fully closed position with respect to the vehicle body.

3. The wire harness according to claim 1, wherein
when the slide door is at the fully open position with respect to the vehicle body, the harness body is routed on the side of the slide direction during the opening operation with respect to the link mechanism arranged on a most front side of the vehicle among a plurality of the link mechanisms arranged at intervals in a vehicle vertical direction.

4. The wire harness according to claim 2, wherein
when the slide door is at the fully open position with respect to the vehicle body, the harness body is routed on the side of the slide direction during the opening operation with respect to the link mechanism arranged on a most front side of the vehicle among a plurality of the link mechanisms arranged at intervals in a vehicle vertical direction.

5. The wire harness according to claim 1, wherein
the harness body is routed between two adjacent link mechanisms in a vehicle vertical direction among the plurality of the link mechanisms arranged at intervals in the vehicle vertical direction.

6. The wire harness according to claim 2, wherein
the harness body is routed between two adjacent link mechanisms in a vehicle vertical direction among the plurality of the link mechanisms arranged at intervals in the vehicle vertical direction.

7. The wire harness according to claim 3, wherein
the harness body is routed between two adjacent link mechanisms in a vehicle vertical direction among the plurality of the link mechanisms arranged at intervals in the vehicle vertical direction.

8. The wire harness according to claim 1, wherein
the harness body is routed between an upper link mechanism and a lower link mechanism arranged at an interval in a vehicle vertical direction.

9. The wire harness according to claim 2, wherein
the harness body is routed between an upper link mechanism and a lower link mechanism arranged at an interval in a vehicle vertical direction.

10. The wire harness according to claim 3, wherein
the harness body is routed between an upper link mechanism and a lower link mechanism arranged at an interval in a vehicle vertical direction.
